(19) United States
(12) Patent Application Publication
(10) Pub. No.: US 2024/0420038 A1
(43) Pub. Date: Dec. 19, 2024

(54) SYMMETRY PRUNING TO INCREASE PLANNER SPEED

(71) Applicant: INTERNATIONAL BUSINESS MACHINES CORPORATION, Armonk, NY (US)

(72) Inventors: Michael KATZ, Goldens Bridge, NY (US); Junkyu LEE, San Diego, CA (US)

(21) Appl. No.: 18/342,817

(22) Filed: Jun. 28, 2023

Related U.S. Application Data
(60) Provisional application No. 63/508,492, filed on Jun. 15, 2023.

(51) Int. Cl. G06Q 10/04

(52) U.S. Cl. CPC G06Q 10/04

(57) ABSTRACT

Computer implemented methods, systems, and computer program products include program code executing on a processor(s) that obtains a planning problem. The program code obtains a bound on a number of plans (to address the planning problem). The program code identifies symmetries of the planning problem. The program code utilizes the symmetries to identify an orbit search space of the planning problem. The program code executes a two-phase search iteratively over the orbit space to identify surrogate plans in the orbit space. The program code generates new plans by utilizing the surrogate plans and the symmetries of the planning problem to map the surrogate plans to new plans. The program code extends the new plans. The extended new plans comprise the set of solutions for the planning problem.

### CROSS-REFERENCE TO RELATED APPLICATION

This application claims priority to U.S. Provisional Application No. 63/508,492, filed Jun. 15, 2023, entitled “SYMMETRY PRUNING TO INCREASE PLANNER SPEED,” which is incorporated herein by reference in its entirety, for all purposes.

### BACKGROUND

The present invention relates generally to the field of artificial intelligence (AI) in computing and specifically, reducing central processing unit (CPU) time to process instructions that problem solving in top-quality planning.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

Automated planning and scheduling, referred to as AI planning is a branch of AI that concerns the realization of strategies or action sequences, typically for execution by intelligent agents, autonomous robots, and/or unmanned vehicles. Because solutions in AI planning are more complex than classical control and classification problems, AI planning problems are generally discovered and optimized in multidimensional space. AI planning, also referred to as automated planning, aims to solve problems, modeled in an input language, that involve finding a strategy of action provided they are modeled in a suitable input language. Optimal planning in AI planning refers to finding one best solution to a problem. A planning problem in AI refers to a problem with some initial starting state, which one wishes to transform into a desired goal state through the application of a set of actions.

### SUMMARY

Shortcomings of the prior art are overcome, and additional advantages are provided through the provision of a computer-implemented method for generating a set of solutions for a planning problem. The computer-implemented method can include: obtaining, by the one or more processors, a planning problem; obtaining, by one or more processors, a bound on a number of plans; identifying, by the one or more processors, symmetries of the planning problem; utilizing, by the one or more processors, the symmetries to identify an orbit search space of the planning problem; executing, by the one or more processors, a two-phase search iteratively over the orbit space to identify surrogate plans in the orbit space; generating, by the one or more processors, new plans, wherein the generating comprises utilizing the surrogate plans and the symmetries of the planning problem to map the surrogate plans to new plans; and extending, by the one or more processors, the new plans with the symmetries, wherein the extended new plans comprise the set of solutions for the planning problem.

Shortcomings of the prior art are overcome, and additional advantages are provided through the provision of a computer program product for generating a set of solutions for a planning problem. The computer program product comprises a storage medium readable by a one or more processors and storing instructions for execution by the one or more processors for performing a method. The method includes, for instance: obtaining, by the one or more processors, a planning problem; obtaining, by one or more processors, a bound on a number of plans; identifying, by the one or more processors, symmetries of the planning problem; utilizing, by the one or more processors, the symmetries to identify an orbit search space of the planning problem; executing, by the one or more processors, a two-phase search iteratively over the orbit space to identify surrogate plans in the orbit space; generating, by the one or more processors, new plans, wherein the generating comprises utilizing the surrogate plans and the symmetries of the planning problem to map the surrogate plans to new plans; and extending, by the one or more processors, the new plans with the symmetries, wherein the extended new plans comprise the set of solutions for the planning problem.

Shortcomings of the prior art are overcome, and additional advantages are provided through the provision of a system for generating a set of solutions for a planning problem. The system includes: a memory, one or more processors in communication with the memory, and program instructions executable by the one or more processors via the memory to perform a method. The method includes, for instance: obtaining, by the one or more processors, a planning problem; obtaining, by one or more processors, a bound on a number of plans; identifying, by the one or more processors, symmetries of the planning problem; utilizing, by the one or more processors, the symmetries to identify an orbit search space of the planning problem; executing, by the one or more processors, a two-phase search iteratively over the orbit space to identify surrogate plans in the orbit space; generating, by the one or more processors, new plans, wherein the generating comprises utilizing the surrogate plans and the symmetries of the planning problem to map the surrogate plans to new plans; and extending, by the one or more processors, the new plans with the symmetries, wherein the extended new plans comprise the set of solutions for the planning problem.

Computer systems and computer program products relating to one or more aspects are also described and may be claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present invention;

FIG. 2 is an examples that contrasts the performance of various AI planners;

FIG. 3 workflow that provides an overview of various aspects performed by the program code (executing on one or more processors) in some embodiments of the present invention;

FIG. 4 is an illustrative example of a planning problem to which aspects of the present examples can be applied;

FIG. 5 is an illustrative example of aspects of a planning problem to which aspects of the present examples can be applied;

FIG. 6 is an illustrative example of aspects of a planning problem to which aspects of the present examples can be applied;

FIG. 7 is an algorithm that can be integrated into various examples herein;

FIG. 8 workflow that provides an overview of various aspects performed by the program code (executing on one or more processors) in some embodiments of the present invention; and

FIG. 9 is a flow chart that provides an overview of various aspects performed by the program code (executing on one or more processors) in some embodiments of the present invention.

### DETAILED DESCRIPTION

Automated planning or AI planning is a sub-area of AI that includes solving problems where the solution involves finding a strategy of action. Program code, executed by at least one processor, solves these problems, in part, by the program code modeling the problems in an effective input language. This automated planning includes finding one best solution to a problem. Although various optimal planners exist and can be used to solve certain very specific types of problems, when dealing with diverse problems of a high complexity, including PSPACE-hard problems, there is no present approach that can handle the breadth of problems of this complexity. PSPACE (polynomial space) refers to a set of all decision problems that can be solved by a Turing machine using a polynomial amount of space. A problem considered PSPACE-hard if an algorithm that solves the problem can be transformed into an algorithm that solves any other problem in PSPACE in a polynomial amount of time. The term PSPACE-hard is used to designate a complexity class in theoretical computer science that captures the set of decision problems that can be solved by a deterministic Turing machine using a polynomial amount of memory space in which the problems are unlikely to have efficient solutions.

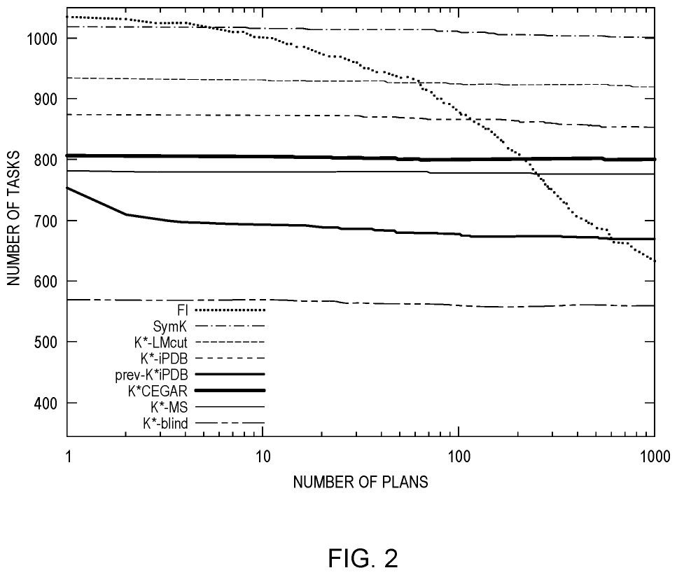

An example of a type of problem that various AI planning approaches can be used to attempt to solve is unordered top-quality planning. This problem can be articulated as given q, the program code tries to find all plans of cost up to q times optimal. In solving this problem, the program code may skip re-orderings of the plans. Re-orderings can be skipped because, from an application perspective, often two valid plans that are re-orderings of each other are equivalent. Thus, if the program code were to provide both, it would be providing duplicative information and would waste processing time and resources in generating and providing both plans. Existing AI planning approaches to solving unordered top-planning problems include, but are not limited to, a symbolic search (SymK) based approach (i.e., program code provides top-quality plans and checks duplicates based on unordered variants), a forbid iterative (FI) based approach (i.e., program code utilizes cost-optimal planners to find a single plan and iteratively reformulates a planning problem to reduce a space of plans), and a K* search based approach (i.e., program code utilizes a two-phase search to iteratively develop a search space and attempts to extract top-quality solutions, which includes the program code finding all top-quality plans and checking duplicates based on unordered variants). A drawback shared by these approaches, as presently utilized, is that they are time and resource intensive. Thus, there is a need to increase the speed at which AI planners operate without increasing the processing resources to accommodate this change in speed. FIG. 2 is a graph 200 that contrasts these various approaches and shows the number of tasks versus the number of plans returned using SymK, FI, and K* search based approaches.

Embodiments of the present invention are inextricably tied to computing and are directed to a practical application. AI planning is a branch of AI, which is inextricably tied to computing. However, the unordered top-quality planning problems that are solved by aspects of embodiments of the present invention also enable improvements to the technical computing field. As mentioned earlier, the examples herein increase the speed at which a processor can derive solutions to unordered top-quality planning problems, thus reducing CPU time. Additionally, these unordered top-quality planning problems are specific challenges in computing, including but not limited to, hypothesis exploration for malware detection in computing systems, scenario planning for enterprise risk management, state projection, and automated large-scale data analysis. Plan recognition through AI planning can detect malware because the program code (executing on one or more processors) can detect malware based on the program code deriving potentially unreliable observations from network traffic. In a healthcare setting, AI planning can assist care providers in early detection of health complications in an intensive care unit setting. There are examples of AI planning being utilized in the energy domain, including to project the price of oil and volume of oil produced into the future (e.g., fifteen years into the future). In the aforementioned risk management setting, AI planning can be utilized to assist financial organizations in identifying and managing emerging risks. Thus, aspects of the examples herein can be integrated into systems that solve various challenges that are unique to computing and given that deriving these solutions is inextricably tied to computing, aspects herein improve the functioning of the computing system processing the unordered top-quality planning problem by reducing CPU time for deriving a solution. The examples herein are directed to a practical application (and improved computing) at least because the examples herein are directed to computing a set of top-quality plans using symmetry-based pruning, increasing the speed of generating top-quality plans and faster generation of top-quality plans is crucial for the products and services that depend on planning as their computational engines. The example herein, when integrated into certain existing solutions, can speed up the computation of plans, scale better on larger problems in the future, and scale to return more plans that are different from the application perspective.

The examples herein provide significant advantages over existing AI planning approaches. In embodiments of the present invention, not only does can the program code, in various embodiments of the present invention, find structural symmetries of a planning task, when given a plan, find symmetric tasks, when given a state, find a canonical symmetrical state, but it can also, unlike existing approaches, achieve significantly faster processing speeds, by performing a K* search on an orbit space, defined by canonical mapping. In some examples herein, the program code maps paths in the orbit space into plans extended with symmetric plans.

Examples herein include computer-implemented methods, computer system, and computer program products that include program code executing on one or more processor that find top-quality solutions for planning problems. When compared to other approaches, in the examples herein provide significant improvements over existing approaches at least because in the examples herein, the program code can operate more quickly (without requiring additional processing resources to increase the speed of computation) by including symmetry-based pruning in the automated planning performed by the program code. Examples herein provide a significant improvement to a K* based top-quality planner (e.g., an AI planner that utilizes the K* search based approach) through symmetry-based planning. In embodiments of the present invention, the K* search interleaves an A* search and Eppstein's algorithm (EA) to enable program code executing on one or more processors to extract top-k solutions from an explicit graph (A* search space). If not enough solutions are extracted (e.g., a bounding condition is not met), A* search continues until switching criteria triggers. In the examples herein, A* search performance for finding a top−1 plan is improved by utilizing symmetry-based pruning. An A* search approach and/or algorithm is a popular technique used in path-finding and graph traversal such that program code comprising various games and web-based maps utilize an A* algorithm to approximate a shortest path very efficiently. When applying an A* algorithm, the program code would consider a square grid having many obstacles and as input, would obtain a starting cell and a target cell. The program code would apply the A* algorithm to determine how to reach the target cell (if possible) from the starting cell as quickly as possible. By applying the A* algorithm, the program code selects, at each step, the node according to a value, “f”, which is a parameter equal to the sum of two other parameters, “g” and “h”. At each step, the program code selects a node/cell having a lowest “f”, and processes that node/cell. The parameter “g” is the movement cost to move from a starting point to a given square on the grid, following the path generated to get there. The parameter “h” is the estimated movement cost to move from that given square on the grid to the final destination and considered a heuristic approach (e.g., proceeding to a solution by trial and error or by rules that are only loosely defined). The program code, applying the A* algorithm cannot determine an actual distance until it computes the path because of environmental factors that could impact the route. Meanwhile, program code can utilize EA to determine a shortest path as well as all possible deviations from this shortest path. For example, program code applying EA can enumerate, in order of increasing length, the number of shortest paths between a given pair of nodes in a weighted digraph G with n nodes and m arcs. To solve this problem using EA, the program code computes a shortest path tree and then builds a graph D (G) representing all possible deviations from the shortest path. Once the program code generates the graph, it can obtain the shortest paths can be obtained in order of increasing length.

The examples below provide improvements to K* searches when solving planning problems, in part, by program code (executing on one or more processors) defining an orbit space for the planning problem that the program code seeks to solve. Existing extensions of A* include DKS (domain knowledge space) and OSS (orbit search space). In embodiments of the present invention, the program code can perform an A* search with an OSS extension. The program code performs the A* in an orbit space, which is defined by the symmetry relation over states and actions. An orbit of a state is defined by an equivalence relation with two states s and t being equivalent if their symmetrical canonical states are the same c(s)=c(t). The program code can then associate an orbit with canonical states. One the program code has completed the OSS and found a path to a goal in the orbit, the program code can map the path into a plan in the state space. This plan is a solution to top−1. As will be discussed herein in greater detail, in embodiments of the present invention, an A* search in a K* search is replaced with OSS and the program code can map the path to a plan and can also locate all symmetric plans. Because symmetry reduction removes paths in the search space, the program code locates all symmetrical plans so that plans are not missed.

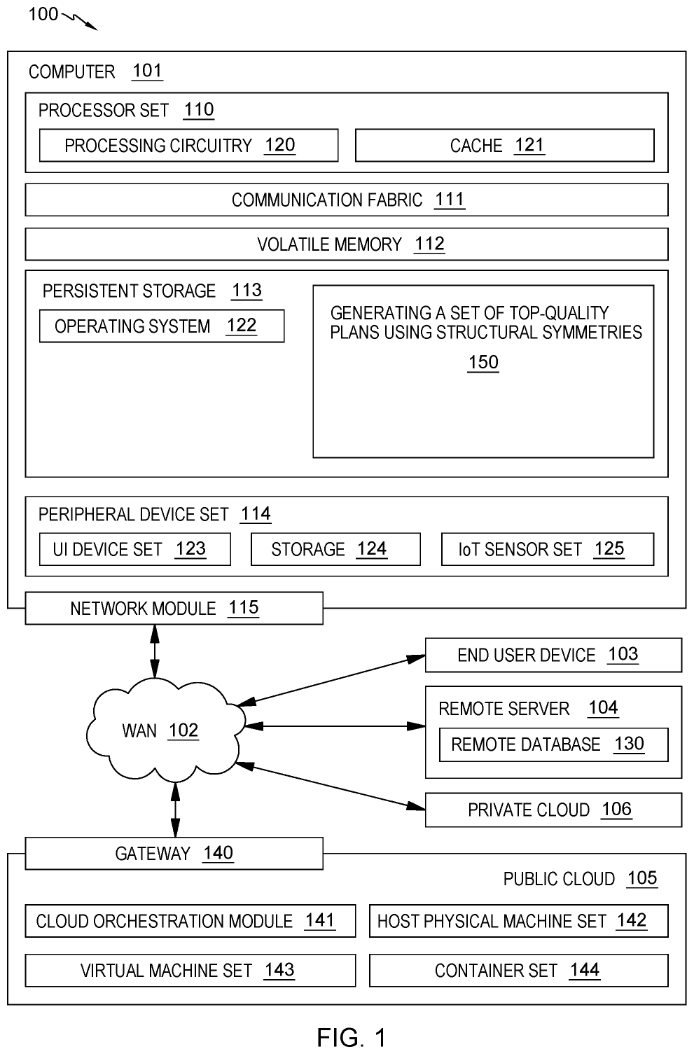

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as a code block for generating a set of top-quality plans using structural symmetries 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

FIG. 2, as aforementioned, is a graph 200, that illustrates differences in various top-k (top quality) planners when the number of tasks versus the number of plans is represented. Embodiments of the present invention include aspects which constitute improvements of K* planners. In a K* search, the program code executes one or more algorithms that iteratively run an A* search and EA until a sufficient number of plans (solutions) is found. This resultant number can be pre-defined. The performance of a K* is thus by the performance of this underlying A* search. The examples herein improve the performance of a K* search by improving the performance of the A* search. The examples herein include improvement to an A* search with an OSS extension. In cost-optimal planning, an OSS improves A* search performance by exploiting symmetry pruning by performing the A* search in the orbit space instead of in state space. The examples herein enable the program code to execute a K* search and in the orbit space to reconstruct plans from the found paths in the orbit space. In the orbit space, nodes correspond to equivalence classes of states, with the equivalence relation based on detecting states as symmetric. The program code detects symmetry utilizing canonical states. When applying OSS, the program code will store one canonical state and hence, it can consume less memory than other space pruning approaches. In the examples herein, the program code transforms an input planning task into a task with a single goal state because a K* search utilizes graphs with a single goal state when generating solutions (plans) for a planning problem. Various methods can be utilized to transform a planning problem into its single goal state, including but not limited to, adding a binary variable to indicate whether a goal was reached. Transforming the goal into its single goal state preserves the symmetries of the input task. The program code then searches an orbital space search (OSS).

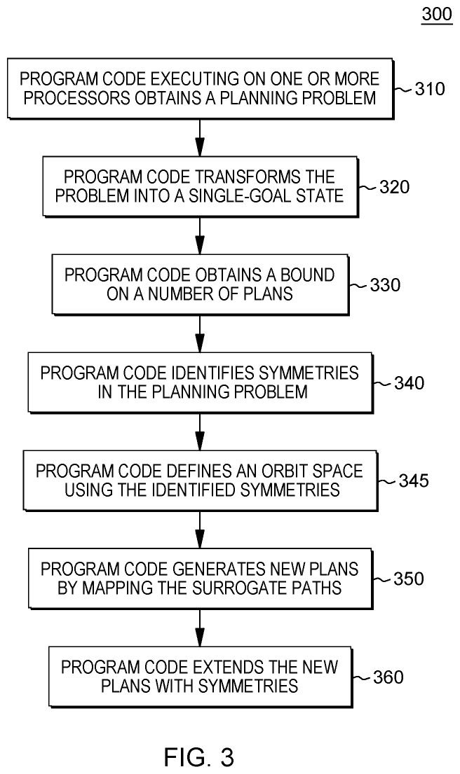

FIG. 3 is a workflow 300 that illustrates various aspects of some embodiments of the present invention. Examples herein comprise program code executing on one or more processors that computes a set of top-quality plans using symmetry pruning. Structural symmetries are graph automorphisms from the syntactic structure of planning tasks. Structural symmetry stabilizes the goal (of a plan). To speed up a search using symmetry, the program code checks whether the states (e.g., s and t) are symmetric or not. In the example illustrated in the workflow 300 of FIG. 3, program code executing on one or more processors obtains a planning problem (310). In some examples, the program code can generate the problem. Additionally, the program code can obtain and solve more than one problem in some examples. A planning problem in AI is a problem with some initial starting state, which the program code can transform into a desired goal state by applying a set of actions. The program code transforms the problem into a single-goal state (320), so that K* can be utilized to solve the problem. The program code obtains a bound (e.g., pre-defined threshold) on a number of plans (e.g., k) (330). The program code identifies symmetries in the planning problem (340). The program code can automatically identify these symmetries. The program code defines an orbit space using the identified symmetries (345). The program code executes a two-phase search iteratively over an orbit space to identify surrogate paths (e.g., surrogate plans) in the orbit space (350). In some examples, the two-phase search is a K* and it is performed over the orbit space. The program code generates new plans by mapping the surrogate paths (e.g., surrogate plans) (360). The program code extends the new plans with symmetries (370). In some examples, the paths are K* paths in the orbit space (called surrogate plans) and the program code maps these paths into plans.

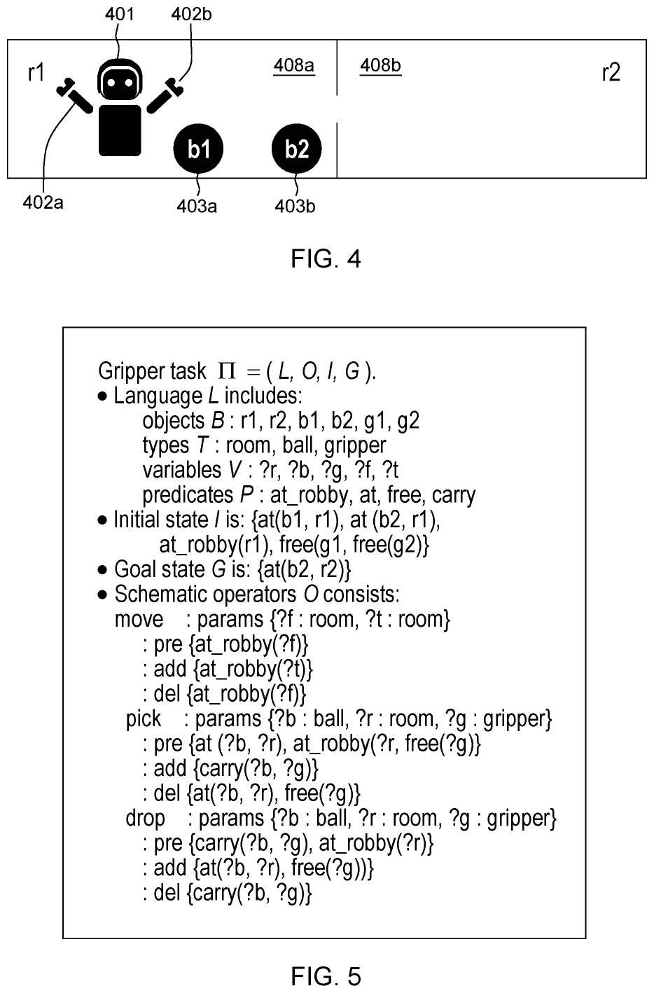

An example of how the program code generates new plans by mapping the surrogate paths (e.g., surrogate plans) (360) can illustrated by a planning problem referred to as the “gripper task.” In this example, illustrated in FIG. 4, a robot 401 has two grippers 402a 402b and each gripper 402a 402b can carry a ball (e.g., b1, b2) 403a 403b. The goal is for the robot 401 to move four balls (only two are illustrated in FIG. 4 as 403a and 403b, from a first room 408a (e.g., r1) to a second room 408b (e.g., r2). In mathematical calculations, the robot is “R”, the grippers are “l” and “r” (a left gripper and a right gripper), the four balls are b₁-b₄ and the rooms are A and B. The gripper planning problem example is referred to throughout the discussion of the various workflows herein to illustrate various aspects of the present invention and does not suggest any limitations to applying the aspects discussed herein to various planning problems. In the gripper task problem, a state can be represented by seven variables (as there are seven objects to represent, the robot, the balls, and the two grippers of the robot): one variable represents the location of the robot is dom(R)={A, B}, four variables represent the locations of the 4 balls {b₁|iϵ[1 . . . 4] with dom(bᵢ)={A, B, R}, two variable represent states of l and r, grippers with domain {E, b₁, b₂, b₃, b₄} for encoding griper holds (of balls), where E means that the gripper is not holding any of the balls (it is empty). One can use give letters to represent the location of the robot and of the four balls at any point in time, ARLBB stands for a state with facts: (R, A), (b1, r), (b₂, l), (b₃, B), (b4, B) (l, b₂), and (r, b₁), meaning the robot is in the room A, the first ball is in the right gripper, the second ball is in the left gripper, the third ball is in room B, and the fourth ball is in room B. There are various actions in the plans, such as pick, drop, and move for manipulating the balls and moving between rooms, abbreviated as follows. P1LA denotes a pick action taking ball b₁ with the left gripper in room A. D2RB denotes a drop action dropping ball b2 from the right gripper in room B, MAB denotes a move from room A to room B. FIG. 5 provides a review of some of the terms discussed related to the gripper planning problem.

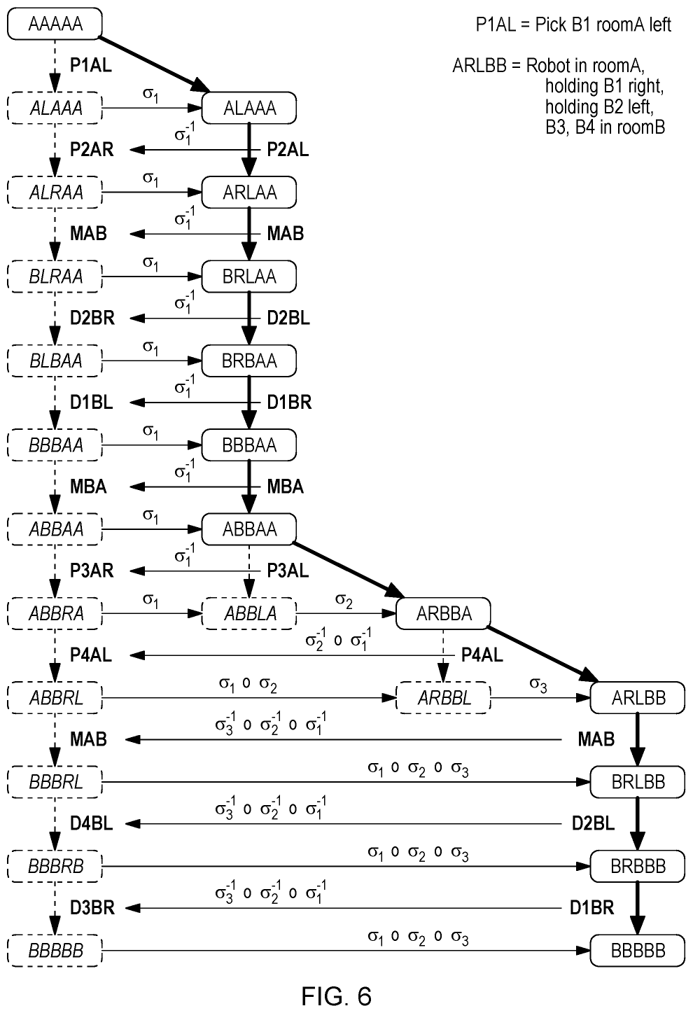

FIG. 6 illustrates a progression in the gripper planning problem that shows how the program code can map surrogate plans to (new) plans (360). The nomenclature in each of the elements is explained below. But the plan in FIG. 6 follows a visually differentiated vertical line starting from the initial state, AAAAA and navigating through ALAAA, to ALRAA, to BLRAA, to BLBAA, to BBBAA, to ABBAA, to ABBRA, to ABBRL, to BBBRL, to BBBRB, to BBBBB. Also designated with the same visuals as part of the plan trace is a progression from ABBAA to ABBLA and a progression from ARBBA to ARBBL. Another visually differentiated trace represents when the program code extracts the plan from a surrogate plan. This trace starts at AAAAA (the initial state) and progresses through ARAAA, to ARLAA, to BRLAA, to BRBAA, to BBBAA, to ABBAA, to ARBBA, to ARLBB, to BRLBB, to BRBBB, to BBBB. Nodes the represent canonical states are visually differentiated from those that represent actual states obtained by applying the actions when these actions are different from the canonical ones. The actual states primarily appear along the plan trace, with the exception of ABBLA (parallel to ABBRA and to the right of ABBRA), and ARBBL (parallel to ABBRL and to the right of ABBRL), which are not along this trace. The canonical states are along the surrogate plan and match each other visually; they are: AAAAA, ARAAA, ARLAA, BRLAA, BRBAA, BBBAA, ABBAA, ARBBA, ARLBB, BRLBB, BRBBB, and BBBBB.

As illustrated in FIG. 6, the program code obtains structural symmetries σ₁, σ₂, and σ₃ from the canonical mappings and utilizes the structural symmetries to map actions on the trace into an applicable sequence of actions that is a plan. All the actions described as being taken by the robot are being facilitated by program code executing on one or more processors controlling the robot, automatically.

As illustrated in FIG. 6, the initial state is AAAAA, meaning that all the balls and the robot are in room A. The destination is BBBBB, meaning that the balls and the robot are in room B. In this illustration at P1AL, the robot picks up the first ball in room A with a left gripper. This means that the next state could be either ALAAA or ARAAA, depending on whether the robot's right or left gripper is now holding the first ball. These states represent a structural symmetry. The robot then picks up the second ball in room A, with the free gripper, so either P2AL or P2AR. Now, the state can be ALRAA or ARLAA, meaning that the robot will have this second ball in the gripper that was not used for the first ball. MAB means that the robot moves from room A to room B. After moving to room B, the state changes to the robot still holding the balls in the same way, but now in the other room, BLRAA or BRLAA (the robot is in room B with the first ball in either the right or left gripper and the second ball in the remaining gripper). The robot then drops the second ball from either the left gripper or the right gripper, D2BR or D2BL, so the robot is still holding the first ball and the state is either BLBAA or BRBAA, depending on whether the robot, who remains in room B, is holding the first ball in the left or right gripper. The robot then drops the first ball from either the left or right gripper, D1BL or D1BR. Now, the robot and the first two balls are in room A and the second two balls are in room B, as represented by the states in black and *red being equivalent (as well as symmetrical), as both are BBBAA. The robot then moves from room B to room A to retrieve additional balls, i.e., MBA. After having moved, the state along both paths is the same with the only state change being the location of the robot, as it is now in room A, ABBAA. As the robot picks up the third ball (which is in room A) with either the left or right gripper, P3AL, P3AR, three possibilities emerge ABBRA, ABBLA, ARBBA, signifying, in all cases, the robot and the fourth ball in room A, but the third ball could be in the right or left gripper (ABBRA, ABBLA) while the second ball is in room B or, the second ball could be in the right gripper with the third ball in room B (ARBBA). Next, in this plan, the robot picks up the fourth ball with the left gripper, P4AL. The resultant states of the objects are either ABBRL (from ABBRA), ARBBL (from ARBBA), or ARLBB (from ARBBA). The robot then moves from room A to room B, MAB. The traces follow 2/3 states, ABBRL and ARLBB (note that there is a reordering based on the balls but there is still a symmetry despite the reordering). The robot is either holding the third and fourth ball or the first and second ball. The robot took two ball into the room and the numbering or each ball can be arbitrary as the tasks can be the same regardless of what the balls were designated. Once the robot reaches room B, the states are BBBRL and BRLBB, representing the change in location of the robot, depending on whether the robot is holding the third and the fourth ball or the first and the second ball. The robot then drops either the fourth or the second ball from the left gripper, D4BL or D2BL, resulting in the dropped ball now being in room B, BBBRB, BRBBB. The robot then drops the ball from its right gripper, D3BR or D1BR, and then, the states are BBBBB and BBBBB on both traces, so symmetries σ₁, σ₂, and σ₃ are present.

FIG. 6 can be understood as a trace-forward algorithm. The structural symmetries illustrated in FIG. 6 fit the model of if σ(x)=y then σ(y)=x (e.g., order 2). These conditions are satisfied during at least four times in the example: 1) permuting the left griper 1 with the right griper r (σₗᵣ); 2) permuting balls b₁ and b₂ (σ₁₂); 3) permuting balls b₂ and b₃ (σ₂₃); and 4) permuting balls b₃ and b₄ (σ₃₄).

Returning to FIG. 3, the program code executes a two-phase search iteratively over an orbit space to identify surrogate paths (e.g., surrogate plans) in the orbit space (350). Because an A* search can expand all symmetric states, in the examples herein, the program code prunes symmetric utilizing the orbital search space (OSS) to enables the program code to explore a compact canonical state transition graph, improving the performance of the K* search overall. The state transition graph is defined relative to a structural symmetry group. By utilizing the OSS, the program code explores the canonical state transition graph (where states are replaced with canonical transition states). Program code utilizing OSS will terminate a search when it reaches its goal states (e.g., FIG. 6, BBBBB) because symmetrical tasks stabilize the goal.

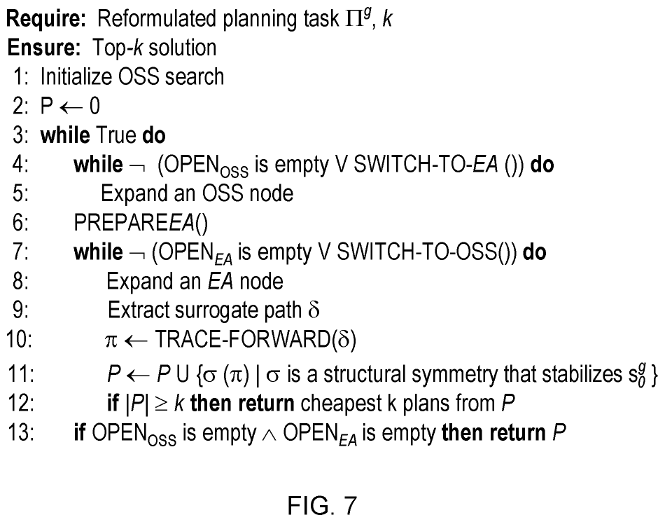

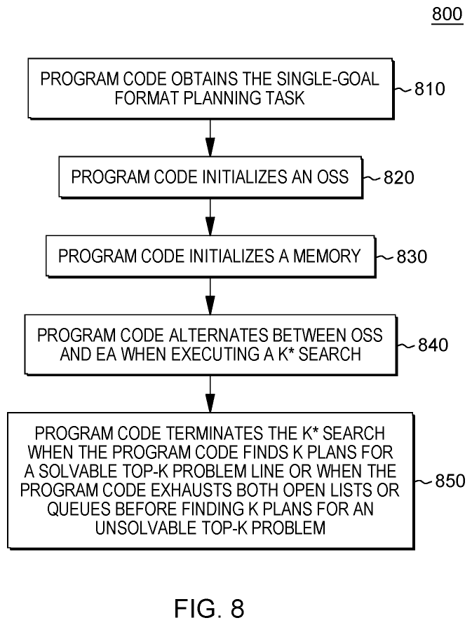

FIG. 7 is an algorithm that illustrates the program code executing a two-phase search iteratively over an orbit space to identify surrogate paths in the orbit space (350). FIG. 8 is a flowchart that provides an overview of aspects of the algorithm of FIG. 7. In this example, the two-phase search is a K* search. As illustrated in FIG. 7, the input to the program code executing the algorithm (on one or more processors) is a reformulated planning task (e.g., the single goal reformulated task). The desired output is one or more top quality solutions. The program code obtains the single-goal format planning task (810). The program code initializes an OSS search (820). To initialize the OSS, the program code defines the search space, detects structural symmetries of the reformulated planning task, and generates data to explore a canonical transition graph for the reformulated planning task (see, line 1 of FIG. 7). The program code initializes a memory (or other storage) to store found plans (see, line 2 of FIG. 7) (830). In executing the K* search, the program code alternates between OSS (see, lines 4-5 of FIG. 7) and EA (see, lines 7-11 of FIG. 7) (840). When executing the search in the OSS, the program code explores the canonical transition graph for the reformulated planning task until it exhausts the search space or when a switch to EA stops the nodes in the OSS from expanding. The switch to EA will stop the nodes in the OSS from expanding when the lowest f value in the OSS queue (OPEN_{OSS}) is no smaller than the one in the EA queue (OPEN_{EA}), or a pre-defined threshold on the number of expanded nodes since a previous switch is reached by the program code. In advance of initiating EA, the program code will generate the structures that support execution of the algorithm, including but not limited to, any databases, queues, or objects (e.g., OPEN_{EA} and graphs). The program code utilizes EA to traverse a path graph which is a subgraph of the canonical transition graph for the reformulated planning task developed by the OSS. When the program code utilizes EA to traverse nodes of the path graph, as part of the K* search, the program code reconstructs a surrogate plan and then decodes it to a plan by utilizing a trace forward algorithm (e.g., FIG. 6). When executing the EA, when the program determines that the lowest values f in the OSS queue (OPEN_{OSS}) is smaller than the lowest value in the EA queue (OPEN_{EA}), the program code forces a switch from EA to OSS. The program code terminates the K* search when the program code finds k plans for a solvable top-k problem line (see, line 11 of FIG. 7) or when the program code exhausts both open lists or queues (e.g., OPEN_{OSS} and OPEN_{EA}) before finding k plans for an unsolvable top-k problem (see, line 12 of FIG. 7) (850).

Various aspects of the algorithm of FIGS. 7-8 enable the K* search to operate more efficiently in finding plans for a solvable problem and represent departures from existing AI planning methods. These aspects include, but are not limited to, utilizing OSS. Aspects of the certain of the examples herein that enhance the K* search include, but are not limited to, the program code initializes an OSS search (as described above), the program code establishing an OSS queue, the program code switching from EA to OSS, the program code reconstructing a surrogate plan from a single-goal transformation of a planning problem, the program code executing a trace-forward algorithm (e.g., FIG. 6) on the surrogate search plan, and the program code utilizing the OSS queue and whether it has been exhausted to return a result.

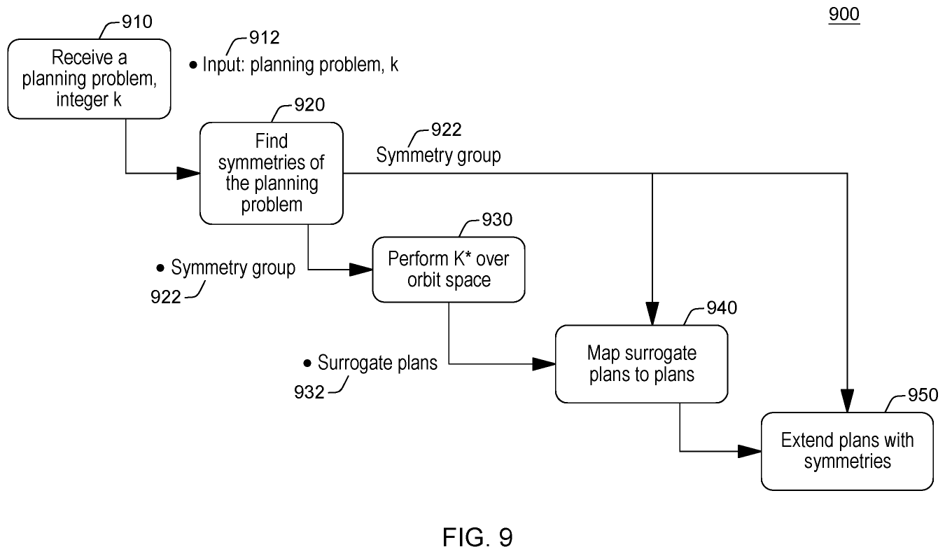

FIG. 9 is an example of an illustration 900 that includes an example of aspects of a workflow described herein. The illustration 900 demonstrates how certain aspects of a workflow in these examples can include portions that are executed in parallel and/or sequentially. As illustrated in FIG. 9, the program code obtains, as input 912, a planning problem, characterized throughout as k (910). The program code finds symmetries of the planning problems resulting in the program code generating a symmetry group 922 (920). The program code provides this symmetry group 922 to various aspects of the workflow. Based on the symmetry group 922, the program code performs a K* search over orbit space, generating surrogate plans 932 (930). The program code obtains the surrogate plans 932 and the symmetry groups 922 and maps the surrogate plans to plans (940). The program code utilizes the mappings and the symmetry group 922 to extend the plans with symmetries (950).

Embodiments of the present invention include computer-implemented methods, computer program products, and computer systems that comprise program code executing on one or more processors that generates a set of solutions for a planning problem. The program code obtains a planning problem. The program code obtains a bound on a number of plans. The program code identifies symmetries of the planning problem. The program code utilizes the symmetries to identify an orbit search space of the planning problem. The program code executes a two-phase search iteratively over the orbit space to identify surrogate plans in the orbit space. The program code generates new plans by utilizing the surrogate plans and the symmetries of the planning problem to map the surrogate plans to new plans. The program code extends the new plans with the symmetries. The extended new plans comprise the set of solutions for the planning problem. A technical advantage of the described computer-implemented methods, computer program products, and computer systems is that implementing the aspects described increases the speed of generating top-quality plans and faster generation of top-quality plans is crucial for the products and services that depend on planning as their computational engines, many of which are discussed herein.

Various additional examples of the computer-implemented methods, computer program products, and computer systems are described below, and these examples, including and excluding the additional examples enumerated below, in any combination (provided these combinations are not inconsistent), increase the speed of generating top-quality plans.

In some examples, the two-phase search comprises a K* search.

In some examples, a first phase of the two phase search comprises an A* search in the orbit search space.

In some examples, a second phase of the two phase search utilizes Eppstein's algorithm.

In some examples, the program code executing the two phase search comprises the program code terminating the two-phase search if a number of plans identified by the two phase search is the bound or if queues for each phase of the two phase search are exhausted by the executing before the number of plans identified by the two phase search is the bound.

In some examples, each solution of the set of solutions comprises a top-quality plan addressing the planning problem.

In some examples, the program code generates the planning problem.

In some examples, the program code automatically implements, in a computing system, at least one solution of the set of solutions.

In some examples, the program code executing the two-phase search includes the program code terminating based on exhausting a layer corresponding the bound.

In some examples, the program code transforms the planning problem into a single-goal form of the planning problem.

In some examples, the program code executing the two-phase search includes the program code executing a first phase search in the orbital search space. The program code executing the two-phase search can also include the program code utilizing Eppstein's algorithm to execute a second phase of the two-phase search.

In some examples, the program code executing the first phase includes the program code exploring a canonical transition graph for the single-goal form of the planning problem reformulated planning task until a switching event occurs, where the switching event is selected from the group consisting of: exhausting the orbital search space and determining that the second phase of the two-phase search stopped nodes in the orbital search space from expanding.

In some examples, the program code executing the second phase includes the program code traversing a path graph which is a subgraph of the canonical transition graph for the single-goal form of the planning problem. Based on the traversing, the program code can reconstruct the surrogate plans. The program code can decode the surrogate plans by utilizing a trace forward algorithm to generate the new plans.

In some examples, the program code determines that a lowest value in a search queue for the first phase is smaller than a lowest value in a search queue for the second phase. The program code can switch to the first phase of the two-phase search.

Although various embodiments are described above, these are only examples. For example, reference architectures of many disciplines may be considered, as well as other knowledge-based types of code repositories, etc., may be considered. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method for generating a set of solutions for a planning problem comprising:
obtaining, by one or more processors, a planning problem;
obtaining, by one or more processors, a bound on a number of plans;
identifying, by the one or more processors, symmetries of the planning problem;
utilizing, by the one or more processors, the symmetries to identify an orbit search space of the planning problem;
executing, by the one or more processors, a two-phase search iteratively over the orbit space to identify surrogate plans in the orbit space;
generating, by the one or more processors, new plans, wherein the generating comprises utilizing the surrogate plans and the symmetries of the planning problem to map the surrogate plans to new plans; and
extending, by the one or more processors, the new plans with the symmetries, wherein the extended new plans comprise the set of solutions for the planning problem.

2. The method of claim 1, wherein the two-phase search comprises a K* search.

3. The method of claim 2, wherein a first phase of the two phase search comprises an A* search in the orbit search space.

4. The method of claim 2, wherein a second phase of the two phase search utilizes Eppstein's algorithm.

5. The method of claim 1, wherein executing the two phase search comprises terminating the two-phase search if a number of plans identified by the two phase search is the bound or if queues for each phase of the two phase search are exhausted by the executing before the number of plans identified by the two phase search is the bound.

6. The method of claim 1, wherein each solution of the set of solutions comprises a top-quality plan addressing the planning problem.

7. The method of claim 1, further comprising:
generating, by the one or more processors, the planning problem.

8. The method of claim 1, further comprising:
automatically implementing, by the one or more processors, in a computing system, at least one solution of the set of solutions.

9. The method of claim 1, wherein executing the two-phase search comprises:
terminating, by the one or more processors, based on exhausting a layer corresponding the bound.

10. The method of claim 1, further comprising:
transforming, by the one or more processors, the planning problem into a single-goal form of the planning problem.

11. The method of claim 10, wherein executing the two-phase search comprises:
executing a first phase search in the orbital search space; and
utilizing Eppstein's algorithm to execute a second phase of the two-phase search.

12. The method of claim 11, wherein executing the first phase comprises:
exploring, by the one or more processors, a canonical transition graph for the single-goal form of the planning problem reformulated planning task until a switching event occurs, where the switching event is selected from the group consisting of: exhausting the orbital search space and determining that the second phase of the two-phase search stopped nodes in the orbital search space from expanding.

13. The method of claim 11, wherein executing the second phase comprises:
traversing, by the one or more processors, a path graph which is a subgraph of the canonical transition graph for the single-goal form of the planning problem;
based on the traversing, reconstructing, by the one or more processors, the surrogate plans; and
decoding, by the one or more processors, the surrogate plans by utilizing a trace forward algorithm to generate the new plans.

14. The method of claim 13, further comprising:
determining, by the one or more processors, that a lowest value in a search queue for the first phase is smaller than a lowest value in a search queue for the second phase; and
switching, by the one or more processors, to the first phase of the two-phase search.

15. A computer system comprising:
a memory; and
one or more processors in communication with the memory, wherein the computer system is configured to perform a method, said method comprising:
obtaining, by the one or more processors, a planning problem;
obtaining, by one or more processors, a bound on a number of plans;
identifying, by the one or more processors, symmetries of the planning problem;
utilizing, by the one or more processors, the symmetries to identify an orbit search space of the planning problem;
executing, by the one or more processors, a two-phase search iteratively over the orbit space to identify surrogate plans in the orbit space;
generating, by the one or more processors, new plans, wherein the generating comprises utilizing the surrogate plans and the symmetries of the planning problem to map the surrogate plans to new plans; and
extending, by the one or more processors, the new plans with the symmetries, wherein the extended new plans comprise the set of solutions for the planning problem.

16. The computer system of claim 15, wherein the two-phase search comprises a K* search.

17. The computer system of claim 16, wherein a first phase of the two phase search comprises an A* search in the orbit search space.

18. The computer system of claim 16, wherein a second phase of the two phase search utilizes Eppstein's algorithm.

19. The method of claim 1, wherein executing the two phase search comprises terminating the two-phase search if a number of plans identified by the two phase search is the bound or if queues for each phase of the two phase search are exhausted by the executing before the number of plans identified by the two phase search is the bound.

20. A computer program product for generating a set of solutions for a planning problem comprising:
a computer readable storage media having program instruction embodied therewith, the program instructions executable by a processing circuit, to cause the processing circuit to:
obtain, by the processing circuit, a planning problem;
obtain, by the processing circuit, a bound on a number of plans;
identify, by processing circuit, symmetries of the planning problem;
utilize, by processing circuit, the symmetries to identify an orbit search space of the planning problem;
execute, by processing circuit, a two-phase search iteratively over the orbit space to identify surrogate plans in the orbit space;
generate, by processing circuit, new plans, wherein the generating comprises utilizing the surrogate plans and the symmetries of the planning problem to map the surrogate plans to new plans; and
extend, by processing circuit, the new plans with the symmetries, wherein the extended new plans comprise the set of solutions for the planning problem.
